(19) United States
(12) Patent Application Publication
(10) Pub. No.: US 2017/0261660 A1
(43) Pub. Date: Sep. 14, 2017

(54) MIRROR HAVING AN IMPROVED DURABILITY

(71) Applicant: SAINT-GOBAIN GLASS FRANCE, Courbevoie (FR)

(72) Inventors: Guillaume LEQUIPPE, Compiegne (FR); Vincent RACHET, Montrouge (FR)

(21) Appl. No.: 15/510,889

(22) PCT Filed: Sep. 14, 2015
(86) PCT No.: PCT/FR2015/052452

§ 371 Date: Mar. 13, 2017

(30) Foreign Application Priority Data
Sep. 15, 2014 (FR) 1458643

(51) Int. Cl. G02B 5/08; C03C 17/36; C03C 17/38; G02B 1/14

(52) U.S. Cl. CPC G02B 5/0808; G02B 1/14; C03C 17/3663; C03C 17/38; C03C 17/3644; C03C 2218/112

(57) ABSTRACT

A mirror includes a transparent substrate, a metallic reflecting layer and a protective layer on the back of the mirror, in which at least one barrier layer to corrosive agents with a thickness after drying of less than 1 μm is located between the metallic reflecting layer and the protective layer, the barrier layer being a layer based on metal alkoxides, oxides, phosphates or sulfides and on organic resin, the alkoxides, oxides, phosphates or sulfides being chosen from titanium or zirconium alkoxides or oxides, tin or zinc oxides, zinc, manganese or tin phosphates and zinc sulfide, alone or as a mixture.

The invention relates to a mirror having an improved durability and also to its process of manufacture.

Mirrors generally comprise a glass substrate on which a metallic reflecting layer has been deposited. This reflecting layer is often made of silver or of aluminum and has a tendency to corrode in the ambient air due to the presence of pollutants present in the atmosphere. It is consequently essential to protect it in order to increase the durability of the mirrors. In silvered mirrors, a treatment with tin, known as “passivation treatment”, is often carried out after the silvering for the purpose, on the one hand, of promoting adhesion of the upper layers and, on the other hand, of potentially improving the resistance to corrosion of the silver. One or more protective layers, for example based on copper or based on paints, are subsequently deposited on the silvered substrate. Mention may be made, for example, of the patent application FR 2 936 340, which describes a mirror comprising a protective coating combining two successive layers of paints of different types. These paint can be of organic type or of inorganic type and be solvent-based or water-based. Typically, the total thickness of this protective layer of paint, once dry, is approximately 50 μm. This thickness makes it possible in particular to provide protection against corrosion and thus improves the durability of the mirror. The paint also makes it possible to obtain the opaqueness on the back face of the mirror, desired in particular for interior mirrors, The choice of the paints and of the processes for the manufacture of the mirrors make it possible to guarantee a protection against corrosion which meets the thresholds imposed by the European standard EN ISO 1036. The mirrors obtained have in particular values which are acceptable during the tests carried out in a copper/acetic acid saline medium (also known under the name of CASS or copper accelerated acetic acid salt spray test described in the standard EN ISO 9227). However, the aim is to further improve the durability of the mirrors, especially under real conditions of chemical stresses, in particular the presence of sulphide corrosion and/or corrosion by chlorides, while keeping the production costs comparable to the solutions currently on the market.

The present invention comes within this context. It has now been found that, by depositing a barrier layer in contact with the paint layer, it is possible to obtain a significant improvement in the protection against corrosion, while maintaining, indeed while decreasing, the thickness of the protective paint layer.

The present invention relates to a mirror which comprises a transparent substrate, a metallic reflecting layer and a protective layer on the back of the mirror, in which at least one barrier layer to corrosive agents with a thickness after drying of less than 1 μm is located between the metallic reflecting layer and the protective layer, said barrier layer being a layer based on metal alkoxides, oxides, phosphates or sulfides and on organic resin, said alkoxides, oxides, phosphates or sulfides being chosen from titanium or zirconium alkoxides or oxides, tin or zinc oxides, zinc, manganese or tin phosphates and zinc sulfide, alone or as a mixture.

The preferred barrier layer is a layer based on organic resin and on titanium, zirconium or manganese alkoxides, oxides and/or phosphates, alone or a mixture. More preferably still, it is a layer based on organic resin and on titanium, zirconium or manganese alkoxides or oxides, alone or as a mixture.

The barrier layer is obtained from a liquid composition of metal alkoxides, oxides, phosphates or sulfides chosen from titanium or zirconium alkoxides or oxides, tin or zinc oxides, zinc, manganese or tin phosphates and zinc sulfite, alone or as a mixture, in an organic resin, everything being in an aqueous or organic solvent.

The metal alkoxides are organometallic compounds of formula M(OR)ₙ, M being a metal of valency n and R an organic group. Compounds of this type exhibit at least one M—O—C bond having an iono-colvanet nature. Preferably, the barrier layer is obtained from a liquid composition which is a solution comprising an organic resin and titanium alkoxides, oxides or phosphates. More preferably still, it is a solution of titanates, that is to say a solution of titanium alkoxides and/or oxide. The organometallic compounds are dissolved in a solvent which can be aqueous or organic. The solvent is, for example, chosen from alcohols, acetates, glycols, such as glycol ethers, chlorinated solvents or aromatic solvents. Mention may be made, for example, of butanol, isopropanol, 1-propoxy-2-propanol or butyl acetate. Advantageously, the solvent used is water.

The organic resin is chosen from acrylic, vinyl, polyurethane, polyester, epoxy, alkyd or styrene resins. Preferably, the organic resin is a resin of polyvinyl alcohol type, such as, for example, polyvinylphenol. The presence of such a resin in the liquid composition makes it possible, after drying and evaporating the solvents, to obtain a barrier layer in which the polymeric matrix plays a beneficial role. Thus, the barrier layer comprises both an organic resin, such as, for example, polyvinylphenol, and inorganic compounds, which guarantees a better cohesion resistance. The presence of an organic resin advantageously makes it possible to improve the cohesion of the constituents of the barrier layer, while contributing flexibility. The adhesion of the barrier layer to the layer on which it is deposited is also provided in part by the organic resin. The organic resin makes it possible to improve the adhesion of the protective overlayer which provides mechanical and optical protection.

The barrier layer advantageously comprises an amount of between 0.1 and 20 mg/m² of titanium. Preferably, the amount of titanium is less than 5 mg/m².

The liquid composition is subsequently hardened by drying. The thickness of the barrier layer is measured by X-ray fluorescence or by optical emission spectrometry (ICP-OES) after drying.

The barrier layer is deposited by the chemical route, for example of sol-gel type, or by the wet route, by magnetic-field-assisted cathode sputtering, by thermal evaporation, by CVD or PECVD, or by pyrolysis.

The presence of such a barrier layer, even of low thickness, since the thickness is than 1 μm, makes it possible to significantly improve the corrosion resistance and consequently the durability of the mirrors according to the present invention. It is not necessary to add, in addition to this barrier layer and the protective layer, other corrosion-inhibiting layers. It is thus possible, for example, to dispense with the presence of a layer of copper paint. In the same way, it becomes possible to use, for the protective layer, a broader range of paints than those which are currently used in processes for the manufacture of mirrors: the paint does not necessarily have to fulfill a protective function against corrosion, in particular sulphide corrosion, this function being provided by the barrier layer.

The thickness of the barrier layer is advantageously less than 100 nm. Preferably, this thickness is less than 40 nm. A fine layer which represents from one to a few molecular layers is concerned. This thickness is measured once the barrier layer has hardened after application of the liquid composition. The mirror according to the invention can also comprise other layers. A tin-based sensitization layer and a palladium-based activation layer may be present between the substrate and the metallic reflecting layer. A passivation layer obtained from a stannous chloride solution may be present on the metallic reflecting layer. This layer performs both a passivation and adhesion role and is located between the metallic reflecting layer and the barrier layer.

A layer of adhesion primer may also be present in the mirror. Conventionally, it is a primer of silane type. This layer can be located either between the barrier layer and the protective layer located at the back of the mirror or optionally between the metallic reflecting layer and the barrier layer. The mirror may optionally comprise several layers of adhesion primer. However, this type of layer is not essential since the barrier layer in the mirrors according to the present invention makes it possible to improve the adhesion of the protective paint layer.

The protective layer deposited at the back of the mirror has essentially an optical and mechanical role. It can be a paint layer or optionally a protective coating of film type based on polymers. Preferably, the protective layer is a paint layer having a thickness of less than 50 μm, preferably of less than 25 μm. The corrosion-resistant effect of the barrier layer makes it possible to reduce the thickness of the protective layer with respect to what is produced today since the current protective paint layers have a thickness often of greater than 50 μm and more generally of between 70 and 100 μm. Advantageously, it is possible to use inexpensive paints, the essential role of which is to provide the desired opacity on the rear face of the mirror. In the interest of observing the EHS standards and in particular the European Directive 2004/42/EC, “Decopaint”, it is advisable to use paints containing less than 130 g/l of organic solvents, thus limiting the emission of volatile organic compounds (VOCs).

The presence of the barrier layer does not have a harmful effect on the hardness of the protective layer placed at the back of the mirror.

The transparent substrate is generally a bent or unbent sheet of mineral or organic glass, the thickness of which varies between 2 and 8 mm. The glass is preferably extra clear, that is to say exhibiting a light transmission of greater than 85%, indeed even of greater than 89%, for a thickness of 3.2 mm. If the glass is organic, it can in particular be made of polycarbonate, of polymethyl methacrylate, of polyethylene terephthalate or of poly(ethylene-co-tetrafluoroethylene).

All of the different layers constituting the mirror are applied on the same side of the transparent substrate.

The metallic reflecting layer, preferably made of silver, has a thickness varying between 500 and 1600 mg/m². For applications as domestic mirrors, such as, for example, bathroom mirrors, a conventional silver layer has a thickness of 700 to 1000 mg/m². On the other hand, for applications as solar mirrors, in which it is necessary for the maximum of the light of the solar spectra to be reflected, the silver layer has a thickness of between 900 and 1600 mg/m². The reflecting layer can also be made of aluminum.

The present invention also relates to a process for the manufacture of a mirror as described above.

The stages of manufacture of a mirror being the application of the barrier layer will not be described in detail. As is known to a person skilled in the art, the manufacture of a mirror comprises several stages before the deposition of the metallic reflecting layer: the surface of the substrate is brightened and then one of its face is sensitized, for example with a stannous chloride solution. It is subsequently possible to activate this same face with a palladium chloride solution. The deposition of the metallic reflecting layer, such as silver, is then carried out by techniques known to a person skilled in the art. The deposition can be carried out in the vapor phase, in particular by CVD, PVD or magnetron, or by the liquid route, in particular starting from a silvering solution.

The process for the manufacture of a mirror according to the present invention comprises an optional stage of sensitization, an optional stage of activation of the surface of the substrate to be coated and a stage of deposition of the metallic reflecting layer. It additionally comprises a stage of deposition and of drying of at least one barrier layer and a stage of deposition and drying of a protective layer deposited on the barrier layer.

The deposition of the barrier layer is advantageously carried out by the chemical route, for example by the wet route, such as the sol-gel route, by the liquid route, by magnetic-field-assisted cathode sputtering, by thermal evaporation, by CVD or PECVD, or by pyrolysis.

Preferably, the deposition of the barrier layer is carried out by the liquid route by spraying, with a roller, by dipping, by curtain coating or by sprinkling drying. The liquid composition is diluted so that the thickness of the wet film applied by one of these processes is homogeneous and covering and corresponds to the thickness of the targeted barrier layer, once dried or hardened. For a substrate made of glass, the technique of spraying the prediluted liquid composition, followed by blowing with an air knife, is preferably envisaged to guarantee a fine and homogenous thickness.

After deposition, the barrier layer is dried, under air or by IR curing. The drying time is determined as a function of the thickness of the barrier layer.

The protective paint layer can be applied by different techniques: spraying, curtain, film drawer, roller. The drying temperatures and times of the paint layer can vary as a function of the type of paint used and of the thickness of the paint layer. The drying can be carried out under hot air or else by IR curing. If the paint is crosslinkable under UV radiation, the drying stage can be carried out under UV lamps.

If the barrier layer and the protective paint layer are applied to a mirror having its final form (already cut out and/or bent), these layers are advantageously applied by the curtain technique, which makes it possible to cover the edges of the mirror over its entire perimeter.

In the following examples, different tests were carried out in order to characterize the mirrors obtained.

Measurements of thickness of layers are carried out by micrometric section measurement methods (Paint Borer 518 device from Erichsen). The results obtained are expressed in pm.

Measurements of adhesion of the layers are determined with the automatic cross hatch device from Erichsen (type 430) and correspond to the cross hatch test described in the standard NF ISO 2409 on paints and varnishes. This test consists in carrying out a visual interpretation of the surface of the cross hatch pattern on which flaking has been produced with a 1 mm comb. The classification takes place on a scale of 0 to 5 according to whether the layer comes off to a greater or lesser extent. A value of 0 indicates a very good adhesion of the layer.

In order to meet the specifications imposed by the standard ISO 2409, the mirrors have to have a grade of less than 2 in the adhesion test.

The measurements for assaying the titanates, when they are present in the barrier layer, are carried out by X-ray fluorescence.

A test has been developed to evaluate the resistance of the barrier layer and of the protective paint layer to the diffusion of sulfur-comprising compounds. In order to carry out this test, the percentage of light reflection is analyzed as a function of the time on samples, the layer to be analyzed of which is covered with rubber. The samples on which the rubber is laid down are placed in a drying oven at 130° C. in order to accelerate the process of diffusion of the sulfur-comprising compounds present in the rubber. Light reflection measurements are subsequently carried out after 60 and 180 minutes, and the percentage of loss of light reflection is estimated with respect to a value measured at T=0 (before the positioning of the rubber).

Different mirrors with a size of 400 mm×300 mm were prepared: the metallic reflecting layer is made of silver and has a thickness of approximately 750 mg/m². The substrate is made of glass of the Planilux® type.

By way of comparison, mirrors devoid of barrier layer were prepared: they are reference mirrors, which comprise a tin passivation layer deposited by the liquid route, with a thickness of approximately ten nanometers, and a silane-based adhesion primer layer with a thickness of approximately 10 nm located between the metallic reflecting layer made of silver and the protective paint layer. The difference between these reference mirrors is the type and the thickness of the protective paint layer. Three different types of paint were tested. The different mirrors given by way of comparison are summarized in table 1 below:

TABLE 1

| | | | Thickness |
|---|---|---|---|
| | | | measured after |
| | | | drying at 180° C. |
| | | Wet thickness | for 15 min (in |
| Reference | Paint | deposited (in μm) | μm) |
| REF. 1 | Solvent-based paint | 100 | 20 |
| | P1 (Fenzi LF3 Grey) | | |
| REF. 2 | Solvent-based paint | 160 | 40 |
| | P1 (Fenzi LF3 Grey) | | |
| REF. 4 | Water-based paint | 170 | 40 |
| | P2 (Valspar GMS6- | | |
| | 0455-02) | | |
| REF. 6 | Water-based paint | 130 | 40 |
| | P3 (Fenzi WBLF4) | | |

A series of mirrors according to the invention was prepared: these mirrors comprise a barrier layer directly deposited on a tin passivation layer deposited on the metallic reflecting layer and under the protective paint layer. They are mirrors 1 to 6. The barrier layer was obtained by depositing on the passivation layer, by spraying, a liquid composition which is a solution of titanates in an organic resin of polyvinylphenol type (Granodine 1456, sold by Henkel) diluted to 10% in demineralized water. After application of a thin film of Granodine deposited by the liquid route, the layer is dried under air at a temperature of approximately 70° C. The differences between the mirrors 1 to 6 lie in the thickness of the barrier layer and also in the thickness and the nature of the protective paint layer.

The different mirrors prepared according to the present invention are summarized in table 2 below.

TABLE 2

| | Thickness of the | | | |
|---|---|---|---|---|
| | barrier layer | Assaying of | | Thickness of |
| | after drying in | the titanium | | the layer of |
| | nm (estimated | in the barrier | Type of | paint after |
| Reference | by calculation) | layer (mg/m²) | paint | drying (in μm) |
| Mirror 1 | 5-10 | 3.3 | P2 | 20 |
| Mirror 2 | 5-10 | 3.3 | P2 | 40 |
| Mirror 3 | 5-10 | 3.3 | P3 | 20 |
| Mirror 4 | 10-20 | 7.1 | P2 | 20 |
| Mirror 5 | 10-20 | 7.1 | P2 | 40 |
| Mirror 6 | 10-20 | 7.1 | P3 | 20 |

The thicknesses of the barrier layers are calculated from the assayings of titanium present in the layer per unit of surface area and from the concentration by weight of titanium, which makes it possible to know the thickness in mg/m².

The adhesions measured in the cross hatch test for each of the samples are given below. The performances in sulphide corrosion of solvent-based paints and of water-based paints applied at 20 and 40 μm were evaluated in drying ovens at 130° C. for the different samples. The percentages of loss of light reflection of the different samples tested at 60 minutes and at 180 minutes are summarized in table 3 below.

TABLE 3

| | | % of loss of | % of loss of |
|---|---|---|---|
| | | light reflection | light reflection |
| Sample | Adhesion | at 60 min | at 180 min |
| REF. 1 | 0 | 90 | 90 |
| REF. 2 | 0 | 60 | 90 |
| REF. 4 | 0 | 78 | 86 |
| REF. 6 | 0 | 70 | 85 |
| Mirror 1 | 0 | 15 | 80 |
| Mirror 2 | 1 | 20 | 80 |
| Mirror 3 | 0 | 20 | 80 |
| Mirror 4 | 0 | 15 | 75 |
| Mirror 5 | 1 | 15 | 80 |
| Mirror 6 | 0 | 5 | 55 |

On comparing the mirrors 1, 2, 4 and 5 according to the present invention, comprising a barrier layer against corrosion, with the mirror REF. 4, it is found that, after 60 min, the percentage of decrease is markedly smaller for the mirrors according to the present invention than for the reference mirror. After 180 min, the values obtained for the mirrors of the invention so remain lower than that of the comparative mirror. This shows the beneficial effect of the barrier layer on the resistance to sulphide corrosion, even for samples which have a protective paint layer of low thickness, that is to say of 20 μm (mirror 1 and mirror 4).

The results obtained for the mirror 6 also show a very good resistance to sulphide corrosion.

### COMPARATIVE EXAMPLE

A mirror was prepared as described above by using, as barrier layer, a liquid composition which is an aqueous solution of titanates, without organic resin (Bonderite M-NT 30002), diluted to 10% in demineralized water. After application of a thin film of Bonderite deposited by liquid route on the passivation layer, the layer is dried under air at a temperature of approximately 70° C. The layer thus obtained has a titanium content of 5 mg/m². A layer of paint of water-based type (Fenzi) with a thickness of 40 μm is subsequently applied to the barrier layer by the curtain technique.

Measurements of adhesion of layers were carried out on this sample and the value obtained was 3, reflecting a poor adhesion of the layers to the substrate, not compatible with the standards enforced in the field of mirrors.

These results clearly show the advantage of the barrier layers based on organic resin and on solution of titanates for improving both the adhesion of the layers and the resistance to sulphide corrosion.

1. A mirror comprising a transparent substrate, a metallic reflecting layer and a protective layer on a back of the mirror, wherein at least one barrier layer to corrosive agents with a thickness after drying of less than 1 μm is located between the metallic reflecting layer and the protective layer, said barrier layer being a layer based on metal alkoxides, oxides, phosphates or sulfides and on organic resin, said alkoxides, oxides, phosphates or sulfides being chosen from titanium or zirconium alkoxides or oxides, tin or zinc oxides, zinc, manganese or tin phosphates and zinc sulfide, alone or as a mixture.

2. The mirror as claimed in claim 1, wherein the barrier layer is obtained from a liquid composition based on an organic resin and on titanium, zirconium or manganese alkoxides, oxides and/or phosphates, alone or as a mixture, in an aqueous or organic solvent.

3. The mirror as claimed in claim 2, wherein the liquid composition is a solution comprising an organic resin and titanium alkoxides, oxides or phosphates.

4. The mirror as claimed in claim 2, wherein the liquid composition comprises between 0.1 and 20 mg/m2 of titanium.

5. The mirror as claimed in claim 1, wherein the organic resin is chosen from acrylic, vinyl, polyurethane, polyester, epoxy, alkyd or styrene resins.

6. The mirror as claimed in claim 1, wherein the thickness of the barrier layer after drying is less than 100 nm.

7. The mirror as claimed in claim 1, further comprising a passivation layer based on a stannous chloride solution on the metallic reflecting layer.

8. The mirror as claimed in claim 1, further comprising a adhesion primer layer placed between the metallic reflecting layer and the barrier layer or between the barrier layer and the protective layer.

9. The mirror as claimed in claim 1, wherein the protective layer is a layer of paint having a thickness of less than 50 μm.

10. The mirror as claimed in claim 1, wherein the protective paint layer is based on a paint comprising less than 130 g/l of organic solvents.

11. A process for the manufacture of a mirror as claimed in claim 1, comprising optionally performing a stage of sensitization of a surface of the substrate, optionally performing a stage of activation of the surface of the substrate to be coated and performing a stage of deposition of the metallic reflecting layer, the method further comprising performing a stage of deposition and of drying of at least one barrier layer and a stage of deposition and drying of a protective layer deposited on the barrier layer.

12. The process as claimed in claim 11, further comprising performing a stage of deposition of a adhesion primer layer after the stage of deposition of the metallic reflecting layer and before the stage of deposition of the barrier layer.

13. The process as claimed in claim 11, wherein the deposition of the barrier layer is carried out by liquid route, by magnetic-field-assisted cathode sputtering, by thermal evaporation, by CVD or PECVD, by pyrolysis, or by chemical route.

14. The process as claimed in claim 12, wherein the deposition of the barrier layer is carried out by liquid route by spraying, with a roller, by dipping, by curtain coating or by sprinkling drying.

15. The process as claimed in claim 11, wherein the drying of the barrier layer is carried out under air or by IR curing.

16. The mirror as claimed in claim 5, wherein the organic resin is a polyvinyl alcohol resin,

17. The mirror as claimed in claim 16, wherein the organic resin is polyvinylphenol.

18. The mirror as claimed in claim 6, wherein the thickness of the barrier layer after drying is less than 40 nm.

19. The mirror as claimed in claim 9, wherein the protective layer is a layer of paint having a thickness of less than 25 μm.

20. The process as claimed in claim 13, wherein the deposition of the barrier layer is carried out by wet route.

21. The process as claimed in claim 20, wherein the deposition of the barrier layer is carried out by sol-gel route.
